(19) United States
(12) Patent Application Publication
(10) Pub. No.: US 2025/0286590 A1
(43) Pub. Date: Sep. 11, 2025

(54) NODES AND METHODS FOR ENHANCED ML-BASED CSI REPORTING

(71) Applicant: Telefonaktiebolaget LM Ericsson (publ), Stockholm (SE)

(72) Inventors: Roy TIMO, Kungsängen (SE); Konstantinos VANDIKAS, Solna (SE); Henrik RYDÉN, Stockholm (SE)

(21) Appl. No.: 18/858,874

(22) PCT Filed: Apr. 28, 2023
(86) PCT No.: PCT/EP2023/061233

§ 371 Date: Oct. 22, 2024

(30) Foreign Application Priority Data
Apr. 29, 2022 (GR) 20220100356

(51) Int. Cl. H04B 7/06; G06N 3/0455; H04W 24/02

(52) U.S. Cl. CPC H04B 7/0626; G06N 3/0455; H04W 24/02

(57) ABSTRACT

A method, performed by a first node having an AE-encoder, for training the AE-encoder to provide encoded CSI. The method includes providing first AE-encoder data to a second node comprising a first NN-based AE-decoder and having access to channel data representing a communications channel between a first communications node and a second communications node. Then the first node provides second AE-encoder data to a third node comprising a second NN-based AE-decoder and having access to the channel data, and then receives first training assistance information and second training assistance information. The first node determines whether or not to continue the training by updating encoder parameters of the AE-encoder based on the received first and second training assistance information.

### TECHNICAL FIELD

The embodiments herein relate to nodes and methods for enhanced ML-based CSI reporting. A corresponding computer program and a computer program carrier are also disclosed.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas. Each service area or cell area may provide radio coverage via a beam or a beam group. Each service area or cell area is typically served by a radio access node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio access node. The radio access node communicates over an air interface operating on radio frequencies with the wireless device within range of the radio access node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access nodes are directly connected to the EPC core network rather than to RNCs used in 3G networks. In general, in E-UTRAN/LTE the functions of a 3G RNC are distributed between the radio access nodes, e.g. eNodeBs in LTE, and the core network. As such, the RAN of an EPS has an essentially “flat” architecture comprising radio access nodes connected directly to one or more core networks, i.e. they are not connected to RNCs. To compensate for that, the E-UTRAN specification defines a direct interface between the radio access nodes, this interface being denoted the X2 interface.

### Wireless Communication Systems in 3GPP

FIG. 1 illustrates a simplified wireless communication system. Consider the simplified wireless communication system in FIG. 1, with a UE 12, which communicates with one or multiple access nodes 103-104, which in turn is connected to a network node 106. The access nodes 103-104 are part of the radio access network 10.

For wireless communication systems pursuant to 3GPP Evolved Packet System, (EPS), also referred to as Long Term Evolution, LTE, or 4G, standard specifications, such as specified in 3GPP TS 36.300 and related specifications, the access nodes 103-104 corresponds typically to Evolved NodeBs (eNBs) and the network node 106 corresponds typically to either a Mobility Management Entity (MME) and/or a Serving Gateway (SGW). The eNB is part of the radio access network 10, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

For wireless communication systems pursuant to 3GPP 5G System, 5GS (also referred to as New Radio, NR, or 5G) standard specifications, such as specified in 3GPP TS 38.300 and related specifications, on the other hand, the access nodes 103-104 corresponds typically to an 5G NodeB (gNB) and the network node 106 corresponds typically to either an Access and Mobility Management Function (AMF) and/or a User Plane Function (UPF). The gNB is part of the radio access network 10, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid change of core network, LTE eNBs may also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

NR uses Orthogonal Frequency Division Multiplexing (OFDM) with configurable bandwidths and subcarrier spacing to efficiently support a diverse set of use-cases and deployment scenarios. With respect to LTE, NR improves deployment flexibility, user throughputs, latency, and reliability. The throughput performance gains are enabled, in part, by enhanced support for Multi-User Multiple-Input Multiple-Output (MU-MIMO) transmission strategies, where two or more UEs receives data on the same time frequency resources, i.e., by spatially separated transmissions.

A MU-MIMO transmission strategy will now be illustrated based on FIG. 2. FIG. 2 illustrates an example transmission and reception chain for MU-MIMO operations. Note that the order of modulation and precoding, or demodulation and combining respectively, may differ depending on the implementation of MU-MIMO transmission.

A multi-antenna base station with NTx antenna ports is simultaneously, e.g., on the same OFDM time-frequency resources, transmitting information to several UEs: the sequence S⁽¹⁾ is transmitted to UE(1), S⁽²⁾ is transmitted to UE(2), and so on. An antenna port may be a logical unit which may comprise one or more antenna elements. Before modulation and transmission, precoding W_{V}^{(j)} is applied to each sequence to mitigate multiplexing interference—the transmissions are spatially separated.

Each UE demodulates its received signal and combines receiver antenna signals to obtain an estimate Ŝ⁽ⁱ⁾ of the transmitted sequence. This estimate Ŝ⁽ⁱ⁾ for UE i may be expressed as (neglecting other interference and noise sources except the MU-MIMO interference)

$${\hat{S}}^{{( i )}_{=}} {\underbrace{{W}_{U}^{( i )} {H}^{( i )} {W}_{V}^{( i )}}}_{\approx I} {S}^{( i )} + {W}_{U}^{( i )} {H}^{( i )} {\sum }_{j , j \neq i} {W}_{V}^{( j )} {S}^{( j )}$$

The second term represents the spatial multiplexing interference, due to MU-MIMO transmission, seen by UE(i). A goal for a wireless communication network may be to construct a set of precoders {W_{V}^{(j)}} to meet a given target. One such target may be to make
the norm ∥H⁽ⁱ⁾W_{V}⁽ⁱ⁾∥ large (this norm represents the desired channel gain towards user i); and
the norm ∥H^{(j)}W_{V}^{(j)}∥, j≠i small (this norm represents the interference of user i's transmission received by user j).

In other words, the precoder W_{V}⁽ⁱ⁾ shall correlate well with the channel H⁽ⁱ⁾ observed by UE(i) whereas it shall correlate poorly with the channels observed by other UEs.

To construct precoders W_{V}⁽ⁱ⁾, i=1, . . . , J that enable efficient MU-MIMO transmissions, the wireless communication network may need to obtain detailed information about the users downlink channels H(i), i=1, . . . , J. The wireless communication network may for example need to obtain detailed information about all the users downlink channels H(i), i=1, . . . , J.

In deployments where full channel reciprocity holds, detailed channel information may be obtained from uplink Sounding Reference Signals (SRS) that are transmitted periodically, or on demand, by active UEs. The wireless communication network may directly estimate the uplink channel from SRS and, therefore (by reciprocity), the downlink channel H (i).

However, the wireless communication network cannot always accurately estimate the downlink channel from uplink reference signals. Consider the following examples:
In frequency division duplex (FDD) deployments, the uplink and downlink channels use different carriers and, therefore, the uplink channel may not provide enough information about the downlink channel to enable MU-MIMO precoding.
In TDD deployments, the wireless communication network may only be able to estimate part of the uplink channel using SRS because UEs typically have fewer TX branches than RX branches (in which case only certain columns of the precoding matrix may be estimated using SRS). This situation is known as partial channel knowledge.

If the wireless communication network cannot accurately estimate the full downlink channel from uplink transmissions, then active UEs need to report channel information to the wireless communication network over the uplink control or data channels. In LTE and NR, this feedback is achieved by the following signalling protocol:
The wireless communication network transmits Channel State Information reference signals (CSI-RS) over the downlink using N ports.
The UE estimates the downlink channel (or important features thereof such as eigenvectors of the channel or the Gram matrix of the channel, one or more eigenvectors that correspond to the largest eigenvalues of an estimated channel covariance matrix, one or more Discrete Fourier Transform (DFT) base vectors (described below), or orthogonal vectors from any other suitable and defined vector space, that best correlates with an estimated channel matrix, or an estimated channel covariance matrix, the channel delay profile), for each of the N antenna ports from the transmitted CSI-RS.
The UE reports CSI (e.g., channel quality index (CQI), precoding matrix indicator (PMI), rank indicator (RI)) to the wireless communication network over an uplink control channel and/or over a data channel.
The wireless communication network uses the UE's feedback, e.g., the CSI reported from the UE, for downlink user scheduling and MIMO precoding.

In NR, both Type I and Type II reporting are configurable, where the CSI Type II reporting protocol has been specifically designed to enable MU-MIMO operations from uplink UE reports, such as the CSI reports.

The CSI Type II normal reporting mode is based on the specification of sets of Discrete Fourier Transform (DFT) basis functions in a precoder codebook. The UE selects and reports L DFT vectors from the codebook that best match its channel conditions (like the classical codebook precoding matrix indicator (PMI) from earlier 3GPP releases). The number of DFT vectors L is typically 2 or 4 and it is configurable by the wireless communication network. In addition, the UE reports how the L DFT vectors should be combined in terms of relative amplitude scaling and co-phasing.

Algorithms to select L, the L DFT vectors, and co-phasing coefficients are outside the specification scope—left to UE and network implementation. Or, put another way, the 3gpp Rel. 16 specification only defines signaling protocols to enable the above message exchanges.

In the following, “beam” will be used interchangeably with vector. This slight shift of terminology is appropriate whenever the base station has a uniform planar array with antenna elements separated by half of the carrier wavelength.

The CSI type II normal reporting mode is illustrated in FIG. 3, and described in 3gpp TS 38.214 “Physical layer procedures for data (Release 16). The selection and reporting of the L DFT vectors bₙ and their relative amplitudes an is done in a wideband manner; that is, the same beams are used for both polarizations over the entire transmission frequency band. The selection and reporting of the DFT vector co-phasing coefficients are done in a subband manner; that is, DFT vector co-phasing parameters are determined for each of multiple subsets of contiguous subcarriers. The co-phasing parameters are quantized such that e^{jθ}^{ₙ} is taken from either a Quadrature phase-shift keying (QPSK) or 8-Phase Shift Keying (8PSK) signal constellation.

With k denoting a sub-band index, the precoder W_{V}[k] reported by the UE to the network can be expressed as follows:

$${W}_{V} [ k ] = {\sum }_{n} {b}_{n} {a}_{n} {e}^{j {θ}_{n} [ k ]} .$$

The Type II CSI report can be used by the network to co-schedule multiple UEs on the same OFDM time-frequency resources. For example, the network can select UEs that have reported different sets of DFT vectors with weak correlations. The CSI Type II report enables the UE to report a precoder hypothesis that trades CSI resolution against uplink transmission overhead.

NR 3GPP Release 15 supports Type II CSI feedback using port selection mode, in addition to the above normal reporting mode. In this case,
The base station transmits a CSI-RS port in each one of the beam directions.
The UE does not use a codebook to select a DFT vector (a beam), instead the UE selects one or multiple antenna ports from the CSI-RS resource of multiple ports.

Type II CSI feedback using port selection gives the base station some flexibility to use non-standardized precoders that are transparent to the UE. For the port-selection codebook, the precoder reported by the UE can be described as follows

$${W}_{V} [ k ] = {\sum }_{n} {e}_{n} {a}_{n} {e}^{j {θ}_{n} [ k ]} .$$

Here, the vector e is a unit vector with only one non-zero element, which can be viewed as a selection vector that selects a port from the set of ports in the measured CSI-RS resource. The UE thus feeds back which ports it has selected, the amplitude factors and the co-phasing factors.

### Autoencoders for Artificial Intelligence (AI)-Based CSI Reporting

Recently neural network (NN)-based autoencoders (AEs) have shown promising results for compressing downlink MIMO channel estimates for uplink feedback. That is, the AEs are used to compress downlink MIMO channel estimates. The compresses output of the AE is then used as uplink feedback. For example, prior art document Zhilin Lu, Xudong Zhang, Hongyi He, Jintao Wang, and Jian Song, “Binarized Aggregated Network with Quantization: Flexible Deep Learning Deployment for CSI Feedback in MassiveMIMO System”, arXiv, 2105.00354 v1, May 2021 provides a recent summary of academic work.

An AE is a type of Neural Network (NN) that may be used to compress and decompress data in an unsupervised manner.

Unsupervised learning is a type of machine learning in which the algorithm is not provided with any pre-assigned labels or scores for the training data. As a result, unsupervised learning algorithms may first self-discover any naturally occurring patterns in that training data set. Common examples include clustering, where the algorithm automatically groups its training examples into categories with similar features, and principal component analysis, where the algorithm finds ways to compress the training data set by identifying which features are most useful for discriminating between different training examples and discarding the rest. This contrasts with supervised learning in which the training data include pre-assigned category labels, often by a human, or from the output of non-learning classification algorithm.

FIG. 4a illustrates an AE comprising a fully connected (dense) NN. The AE may be divided into two parts:
an encoder (used to compress the input data X), and
a decoder (used to recover important features of the input data).

The encoder and decoder are separated by a bottleneck layer that holds a compressed representation, Y in FIG. 4a, of the input data X. The variable Y is sometimes called the latent representation of the input X. More specifically,
The size of the bottleneck (latent representation) Y is smaller than the size of the input data X. The AE encoder thus compresses the input features X to Y.
The decoder part of the AE tries to invert the encoder's compression and reconstruct X with minimal error, according to some predefined loss function.

The terms latent representation, latent vector, and an encoder output are used interchangeably. Analogously, the terms latent space and encoder output space are used interchangeably and refer to the space of all possible latent vectors, for a given architecture. Similarly, the encoder input space is the space of all possible inputs for a given architecture. The word space can be understood as, e.g., a linear vector space, in the mathematical sense.

AEs may have different architectures. For example, AEs may be based on dense NNs (like FIG. 4a), multi-dimensional convolution NNs, recurrent NNs, transformer NNs, or any combination thereof. However, all AEs architectures possess an encoder-bottleneck-decoder structure.

FIG. 4b illustrates how an AE may be used for AI-based CSI reporting in NR during an inference phase (that is, during live network operation).
The UE estimates the downlink channel (or important features thereof) using configured downlink reference signal(s), e.g., CSI-RS. For example, the UE estimates the downlink channel as a 3D complex-valued tensor, with dimensions defined by the gNB's Tx-antenna ports, the UE's Rx antenna ports, and frequency units (the granularity of which is configurable, e.g., SubCarrier (SC) or subband). In FIG. 4b the 3D complex-valued tensor is illustrated as a rectangular hexahedron with lengths of the sides defined by the gNB's Tx-antenna ports, the UE's Rx antenna ports, and frequency (SC).
The UE uses a trained AE encoder to compress the estimated channel or important features thereof down to a binary codeword. The binary codework is reported to the network over an uplink control channel and/or data channel. In practice, this codeword will likely form one part of a channel state information (CSI) report that may also include rank, channel quality, and interference information. The CSI may be used for MU-MIMO precoding to shape an “energy pattern” of a wireless signal transmitted by the gNB.
The network uses a trained AE decoder to reconstruct the estimated channel or the important features thereof. The decompressed output of the AE decoder is used by the network in, for example, MIMO precoding, scheduling, and link adaption.

The architecture of an AE (e.g., structure, number of layers, nodes per layer, activation function etc) may need to be tailored for each particular use case, e.g., for CSI reporting. The tailoring may be achieved via a process called hyperparameter tuning. For example, properties of the data (e.g., CSI-RS channel estimates), the channel size, uplink feedback rate, and hardware limitations of the encoder and decoder may all need to be considered when designing the AE's architecture.

After the AE's architecture is fixed, it needs to be trained on one or more datasets. To achieve good performance during live operation in a network (the so-called inference phase), the training datasets need to be representative of the actual data the AE will encounter during live operation in a network.

The training process involves numerically tuning the AE's trainable parameters (e.g., the weights and biases of the underlying NN) to minimize a loss function on the training datasets. The loss function may be, for example, the Mean Squared Error (MSE) loss calculated as the average of the squared error between the UE's downlink channel estimate H and the network's reconstruction Ĥ, i.e., ∥H−Ĥ∥². The purpose of the loss function is to meaningfully quantify the reconstruction error for the particular use case at hand.

The training process is typically based on some variant of the gradient descent algorithm, which, at its core, comprises three components: a feedforward step, a back propagation step, and a parameter optimization step. These steps will now be reviewed using a dense AE (i.e., a dense NN with a bottleneck layer, see FIG. 4a) as an example.

Feedforward: A batch of training data, such as a mini-batch, (e.g., several downlink-channel estimates) is pushed through the AE, from the input to the output. The loss function is used to compute the reconstruction loss for all training samples in the batch. The reconstruction loss may be an average reconstruction loss for all training samples in the batch.

The feedforward calculations of a dense AE with N layers (n=1, 2, . . . , N) may be written as follows: The output vector a^{[n]} of layer n is computed from the output of the previous layer a^{[n-1]} using the equations

$${z}^{[ n ]} = {W}^{[ n ]} \cdot {a}^{[ n - 1 ]} + {b}^{[ n ]} , \\ {a}^{[ n ]} = g ( {z}^{[ n ]} ) .$$

In the above equation, W^{[n]} and b^{[n]} are the trainable weights and biases of layer n, respectively, and g is an activation function (for example, a rectified linear unit).

Back propagation (BP): The gradients (partial derivatives of the loss function, L, with respect to each trainable parameter in the AE) are computed. The back propagation algorithm sequentially works backwards from the AE output, layer-by-layer, back through the AE to the input. The back propagation algorithm is built around the chain rule for differentiation: When computing the gradients for layer n in the AE, it uses the gradients for layer n+1.

For a dense AE with N layers the back propagation calculations for layer n may be expressed with the following equations

$$\frac{\partial L}{\partial {a}^{[ n ]}} = {[ {W}^{[ n + 1 ]} ]}^{T} \cdot \frac{\partial L}{\partial {z}^{[ n + 1 ]}} , \\ \frac{\partial L}{\partial {z}^{[ n ]}} = \frac{\partial L}{\partial {a}^{[ n ]}} * {g}^{{[ n ]}^{′}} ( {z}^{[ n ]} ) , \\ \frac{\partial L}{\partial {W}^{[ n ]}} = \frac{\partial L}{\partial {z}^{[ n ]}} \cdot {[ {a}^{[ n - 1 ]} ]}^{T} , \\ \frac{\partial L}{\partial {b}^{[ n ]}} = \frac{\partial L}{\partial {z}^{[ n ]}} ,$$

where * here denotes the Hadamard multiplication of two vectors.

Parameter optimization: The gradients computed in the back propagation step are used to update the AE's trainable parameters. An approach is to use the gradient descent method with a learning rate parameter (α) that scales the gradients of the weights and biases, as illustrated by the following update equations

$${W}^{[ n ]} = {W}^{[ n ]} - α \cdot \frac{\partial L}{\partial {W}^{[ n ]}} , \\ {b}^{[ n ]} = {b}^{[ n ]} - α \cdot \frac{\partial L}{\partial {b}^{[ n ]}} .$$

A core idea here is to make small adjustments to each parameter with the aim of reducing the loss over the (mini) batch. It is common to use special optimizers to update the AE's trainable parameters using gradient information. The following optimizers are widely used to reduce training time and improving overall performance: adaptive sub-gradient methods (AdaGrad), RMSProp, and adaptive moment estimation (ADAM).

The above steps (feedforward, back propagation, parameter optimization) are repeated many times until an acceptable level of performance is achieved on the training dataset. An acceptable level of performance may refer to the AE achieving a pre-defined average reconstruction error over the training dataset (e.g., normalized MSE of the reconstruction error over the training dataset is less than, say, 0.1). Alternatively, it may refer to the AE achieving a pre-defined user data throughput gain with respect to a baseline CSI reporting method (e.g., a MIMO precoding method is selected, and user throughputs are separately estimated for the baseline and the AE CSI reporting methods).

The above steps use numerical methods (e.g., gradient descent) to optimize the AE's trainable parameters (e.g., weights and biases). The training process, however, typically involves optimizing many other parameters (e.g., higher-level hyperparameters that define the model or the training process). Some example hyperparameters are as follows:
The architecture of the AE (e.g., dense, convolutional, transformer).
Architecture-specific parameters (e.g., the number of nodes per layer in a dense network, or the kernel sizes of a convolutional network).
The depth or size of the AE (e.g., number of layers).
The activation functions used at each node within the AE.
The mini-batch size (e.g., the number of channel samples fed into each iteration of the above training steps).
The learning rate for gradient descent and/or the optimizer.
The regularization method (e.g., weight regularization or dropout)

Additional validation datasets may be used to tune such hyperparameters.

The process of designing an AE (hyperparameter tuning and model training) may be iterative and expensive-consuming significant time, compute, memory, and power resources.

AE-based CSI reporting is of interest for 3GPP Rel 18 “AI/ML on PHY” study item for example because of the following reasons:
AEs may include non-linear transformations (e.g., activation functions) that help improve compression performance and, therefore, help improve MU-MIMO performance for the same uplink overhead. For example, the normal Type II CSI codebooks in 3GPP Rel 16 are based on linear DFT transformations and Singular Value Decomposition (SVD), which cannot fully exploit redundancies in the channel for compression.
AEs may be trained to exploit long-term redundancies in the propagation environment and/or site (e.g., antenna configuration) for compression purposes. For example, a particular AE does not need to work well for all possible deployments. Improved compression performance is obtained by learning which channel inputs it needs to (and doesn't need to) reliably reconstruct at the base-station.
AEs may be trained to compensate for antenna array irregularities, including, for example, non-uniformly spaced antenna elements and non-half wavelength element spacing. The Type II CSI codebooks in Rel 15 and 16, for example, use a two-dimensional DFT codebook designed for a regular planar array with perfect half wavelength element spacing.
AEs may be trained to be robust against, or updated (e.g., via transfer learning and training) to compensate for partially failing hardware as the massive MIMO product ages. For example, over time one or more of the multiple Tx and Rx radio chains in the massive MIMO antenna arrays at the base station may fail compromising the effectiveness of Type II CSI feedback. Transfer learning implies that parts of a previous neural network that has learned a different but often related task is transferred to the current network in order to speed up the learning process of the current network.

### SUMMARY

As mentioned above, the AE training process may be a highly iterative process that may be expensive—consuming significant time, compute, memory, and power resources.

Therefore, it may be expected that AE architecture design and training will largely be performed offline, e.g., in a development environment, using appropriate compute infrastructure, training data, validation data, and test data. Data for training, validation, and testing may be collected from one or more of the following examples:
real measurements recorded in live networks,
synthetic radio channel data from, e.g., 3GPP channel models or ray tracing models and/or digital twins, and
mobile drive tests.

Validation data may be part of the development and tuning of the NN, whereas the test data may be applied to the final NN. For example, a “validation dataset” may be used to optimize AE hyperparameters (like its architecture). For example, two different AE architectures may be trained on the same training dataset. Then the performance of the two trained AE architectures may be validated on the validation dataset. The architecture with the best performance on the validation dataset may be kept for the inference phase. In other words, validation may be performed on the same data set as the training, but on “unseen” data samples (e.g. taken from the same source). Test may be performed on a new data set, usually from another source and it tests the NN ability to generalize.

The training of the AE in FIG. 4c has some similarities with split NNs, where an NN is split into two or more sections and where each section consists of one or several consecutive layers of the NN. These sections of the NN may be in different entities/nodes and each entity may perform both feedforward and back propagations. For example, in the case of splitting the NN into two sections, the feedforward outputs of a first section are pushed to a second section. Conversely, in the back propagation step, the gradients of the first layer of the second section are pushed into the last layer of the first section.

The split NN (a.k.a. split learning) was introduced primarily to address privacy issues with user data. In the training of an AE for CSI reporting, however, the privacy (proprietary) aspects of the sections (encoder and decoder) are of interest, and training channel data may need to be shared to calculate reconstruction errors.

### Autoencoders for CSI Reporting—a Multi-Vendor Perspective

In AE-based CSI reporting, the AE encoder is in the UE and the AE decoder is in the wireless communications network, usually in the radio access network. The UE and the wireless communications network are typically represented by different vendors (manufactures), and, therefore, the AE solution needs to be viewed from a multi-vendor perspective with potential standardization (e.g., 3GPP standardization) impacts.

It is useful to recall how 3GPP 5G networks support uplink physical layer channel coding (error control coding).
The UE performs channel encoding and the network performs channel decoding. The channel encoders have been specified in 3GPP, which ensures that the UE's behaviour is understood by the network and may be tested.
   The channel decoders, on the other hand, are left for implementation (vendor proprietary).

If 3GPP specifies one or more AE-based CSI encoders for use in the UEs, then the corresponding AE decoders in the network may be left for implementation (e.g., constructed in a proprietary manner by training the decoders against specified AE encoders. FIG. 4d illustrates a network vendor training of an AE decoder with a specified (untrainable) AE encoder. In short and as described above, a training method for the decoder may comprise comparing a loss function of the channel and the decoded channel, or some features thereof, computing the gradients (partial derivatives of the loss function, L, with respect to each trainable parameter in the AE) by back propagation, and updating the decoder weights and biases.

Some fundamental differences between AE-based CSI reporting and channel coding are as follows:
Channel coding has a long and well-developed academic literature that enabled 3GPP to pre-select a few candidate architectures (or types); namely, turbo codes, linear parity check codes, and polar codes. Channel codes may all be mathematically described as linear mappings that, in turn, may be written into a standard. Therefore, synthetic channel models may be sufficient to design, study, compare, and specify channel codes for 5G.
AEs for CSI feedback, on the other hand, have more architectural options and require many tuneable parameters (possibly hundreds of thousands). It is preferred that the AEs are trained, at least in part, on real field data that accurately represents live, in-network, conditions.

The standardization perspectives on AE-based CSI reporting may be summarized as follows:

AE encoder, or AE decoder, or both may be standardized in a first scenario,
Training within 3GPP (e.g., NN architectures, weights and biases are specified),
   Training outside 3GPP (e.g., NN architectures are specified),
   Signalling for AE-based CSI reporting/configuration are specified,
AE encoder and AE decoder may be implementation specific (vendor proprietary) in a second scenario,
   Interfaces to the AE encoder and AE decoder are specified,
   Signalling for AE-based CSI reporting/configuration are specified.
AE-based CSI reporting has at least the following implementation/standardization challenges and issues to solve:
   The AE encoder and the AE decoder may be complicated NNs with thousands of tuneable parameters (e.g., weights and biases) that potentially need to be open and shared, e.g., through signalling, between the network and UE vendors.
   The UE's compute and/or power resources are limited so the AE encoder will likely need to be known in advance to the UE such that the UE implementation may be optimized for its task.
      The AE encoder's architecture will most likely need to match chipset vendors hardware, and the model (with weights and biases possibly fixed) will need to be compiled with appropriate optimizations. The process of compiling the AE encoder may be costly in time, compute, power, and memory resources. Moreover, the compilation process requires specialized software tool chains to be installed and maintained on each UE.
The AE may depend on the UE's, and/or network's, antenna layout and RF chains, meaning that many different trained AEs (NNs) may be required to support all types of base station and UE designs.
The AE design is data driven meaning that the AE performance will depend on the training data. A specified AE (either encoder or decoder or both) developed using synthetic training data (e.g., specified 3GPP channel models) may not generalize well to radio channels observed in real deployments.
   To reduce the risks of overfitting to synthetic data, one may need to refine the 3GPP channel models and/or share a vast number of field data for training purposes. Here, overfitting means that the AE generalizes poorly to real data, or data observed in field, e.g., the AE achieves good performance on the training dataset, but when used in the real work, e.g. on the test set, it has poor performance.
In specifying either an AE encoder or an AE decoder, there may be a need for 3GPP to agree on at least one reference AE decoder (resp. encoder). These reference models will be needed to provide a minimal framework for discussions and specification work, but they may leave room for vendor specific implementations of the AE decoder (resp. encoder).

Given the above challenges and issues with multi-vendor AE-based CSI reporting, there is a need for a standardized procedure that enables training of the AE-encoder (implemented by a UE/chipset vendor) and multiple AE-decoders (implemented by one or several network vendor(s)). The joint training procedure may protect proprietary implementations of the AE encoder and decoder; that is, it may not expose details of the encoder and/or decoder trained weights and loss function to the other party.

A specific challenge is that different vendors of communications equipment, such as vendors of UEs and base stations may have implemented different AEs which potentially each need to be trained with each other.

An object of embodiments herein may be to obviate some of the above-mentioned problems. Specifically, an object of embodiments herein may be to train CSI AE-encoders for a multi-vendor environment.

According to an aspect, the object is achieved by a method, performed by a first node comprising an Auto Encoder, AE,-encoder, for training the AE-encoder to provide encoded Channel State Information, CSI.

The method comprises providing first AE-encoder data to a second node comprising a first NN-based AE-decoder and having access to channel data representing a communications channel between a first communications node and a second communications node. The first AE-encoder data includes first encoder output data computed with the AE-encoder based on the channel data.

The method further comprises providing second AE-encoder data to a third node comprising a second NN-based AE-decoder and having access to the channel data. The second AE-encoder data includes second encoder output data computed with the AE-encoder based on the same channel data.

The method further comprises receiving, from the second node, first training assistance information.

The method further comprises receiving, from the third node, second training assistance information.

The method further comprises determining, based on the first and second training assistance information, whether or not to continue the training by updating encoder parameters of the AE-encoder based on the received first and second training assistance information. According to a second aspect, the object is achieved by a first node comprising an AE-encoder. The first node is configured to perform the method according to the first aspect above.

According to a third aspect, the object is achieved by a method, performed by a second node comprising an AE-decoder. The method is for assisting in training an AE-encoder, comprised in a first node, to provide encoded Channel State Information, CSI.

The method comprises providing, to the first node, an indication of any one or more of: a loss function used by the AE-decoder; use of a same loss function as a third node comprising a second AE-decoder; an expected minimum performance of a combination of the AE-encoder and the AE-decoder; a margin for an adjustment of a lambda value in a regularize that is acceptable; and meta data about decoder architecture of the decoder.

According to a fourth aspect, the object is achieved by a second node. The second node is configured to perform the method according to the third aspect above.

According to a further aspect, the object is achieved by a computer program comprising instructions, which when executed by a processor, causes the processor to perform actions according to any of the aspects above.

According to a further aspect, the object is achieved by a carrier comprising the computer program of the aspect above, wherein the carrier is one of an electronic signal, an optical signal, an electromagnetic signal, a magnetic signal, an electric signal, a radio signal, a microwave signal, or a computer-readable storage medium.

The above aspects provides a possibility to enable AI-based CSI reporting using proprietary implementations on both the network side and the UE side. Embodiments enable UE/chipset vendors to deploy fewer trained encoders to UEs. Some further advantages are:
Less memory is needed to deploy the encoders to UEs (fewer trained models).
ML model configuration and lifecycle management issues are simplified (fewer trained models to configure, deploy, and monitor).
On the UE side a single encoder is required to be loaded in memory thus avoiding the cost of switching from one encoder to another when the UE switches to a network from a different vendor.

### BRIEF DESCRIPTION OF THE DRAWINGS

In the figures, features that appear in some embodiments are indicated by dashed lines.

The various aspects of embodiments disclosed herein, including particular features and advantages thereof, will be readily understood from the following detailed description and the accompanying drawings, in which:

FIG. 1 illustrates a simplified wireless communication system,

FIG. 2 illustrates an example transmission and reception chain for MU-MIMO operations,

FIG. 3 is a block diagram schematically illustrating CSI type II normal reporting mode,

FIG. 4a schematically illustrates a fully connected, i.e., dense, AE,

FIG. 4b is a block diagram schematically illustrating how an AE may be used for AI-enhanced CSI reporting in NR during an inference phase,

FIG. 4c is a block diagram schematically illustrating how to use an autoencoder for CSI Compression in a training phase by backpropagation,

FIG. 4d is a block diagram schematically illustrating a network vendor training of an AE decoder with a specified, e.g., untrainable, AE encoder,

FIG. 5 illustrates a wireless communication system according to embodiments herein,

FIG. 6 is a block diagram schematically illustrating details of a first node and a second node according to embodiments herein,

FIG. 7 is a schematic flowchart illustrating how a UE or chipset vendor training apparatus may train an AE encoder using a network vendor's training service,

FIG. 8 is a schematic flowchart illustrating AE encoder feedforward propagation, AE encoder backward propagation, and updating of AE encoder weights and biases according to some embodiments herein,

FIG. 9a is a schematic block diagram illustrating an example encoder architecture according to embodiments herein,

FIG. 9b is a flow chart describing a method according to embodiments herein,

FIG. 9c is a flow chart describing a method according to some further embodiments herein,

FIG. 10 is a block diagram schematically illustrating a first node according to embodiments herein,

FIG. 11 is a block diagram schematically illustrating a second node according to embodiments herein,

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14 to 17 are flowcharts illustrating methods implemented in a communication system including a host computer, a base station and a user equipment.

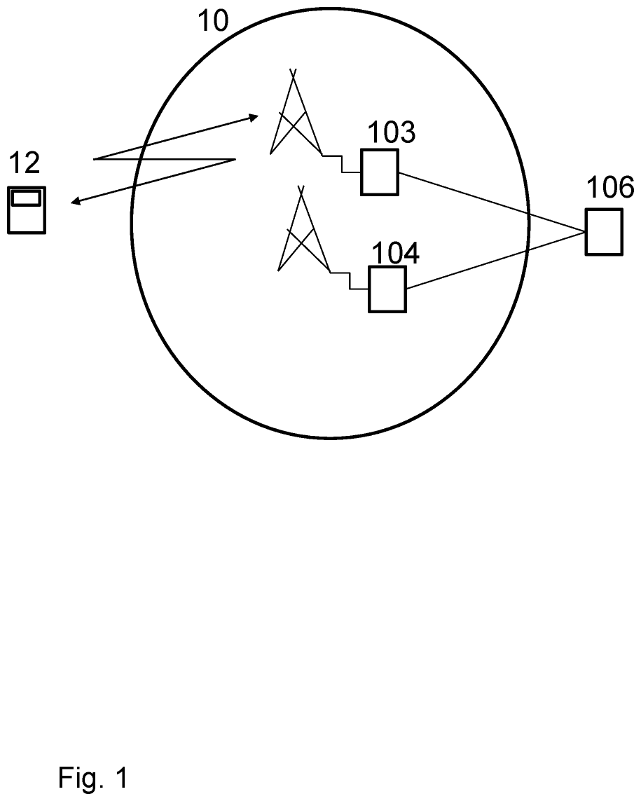

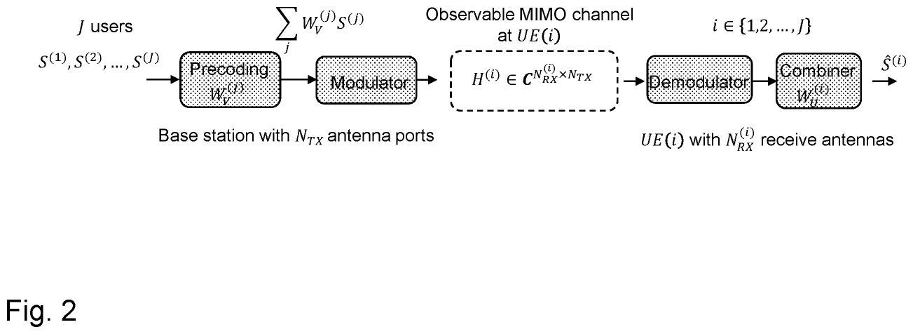

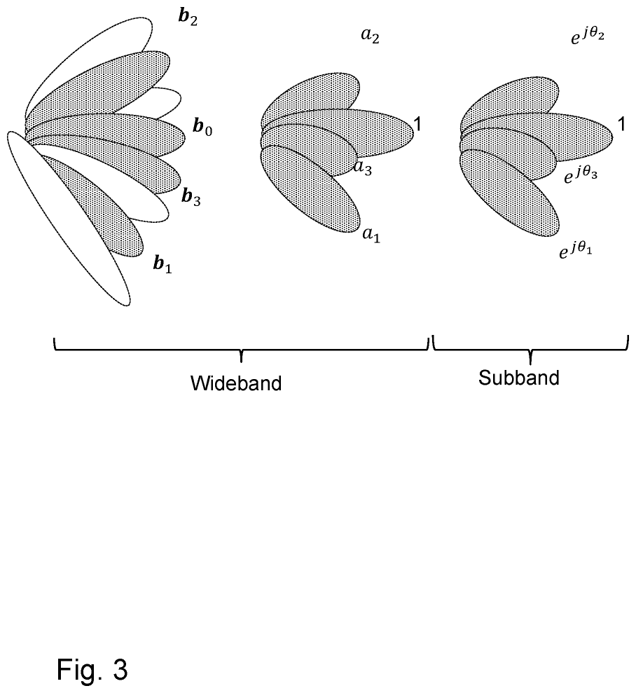

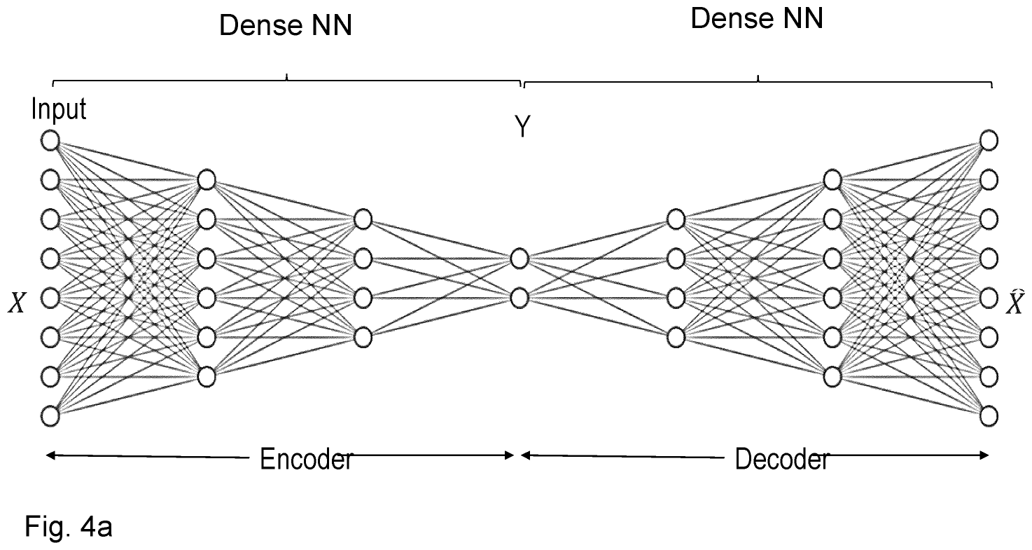

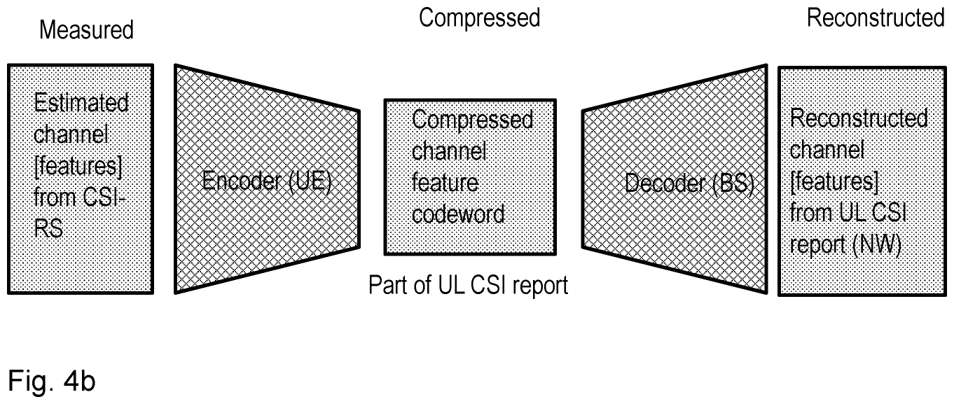

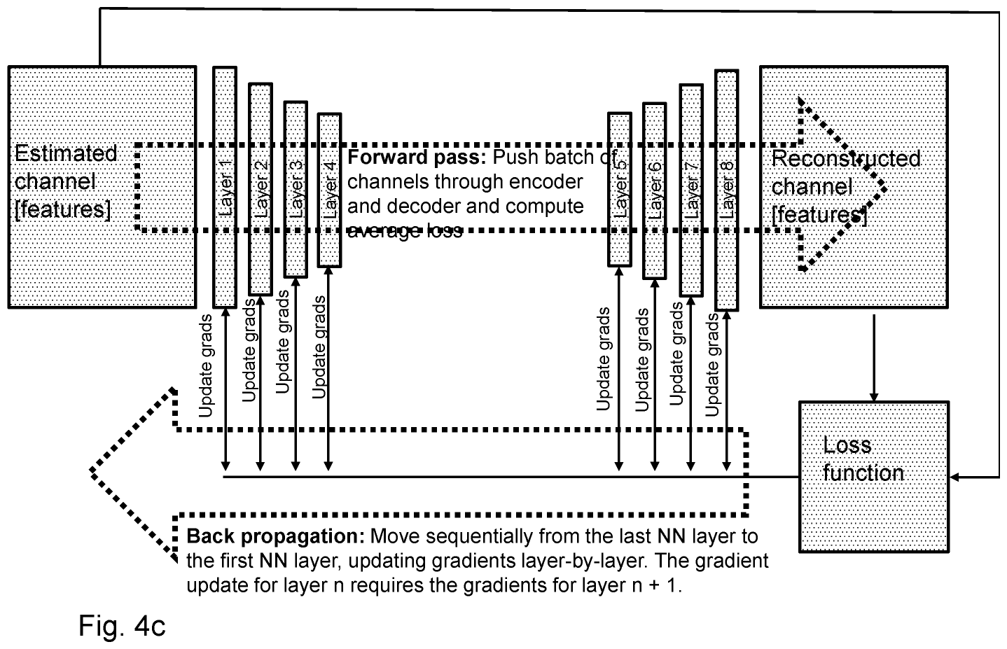

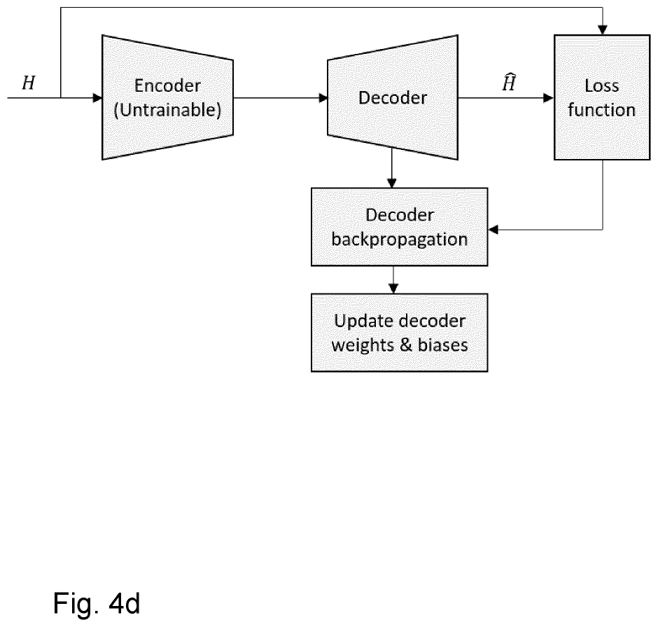

### DETAILED DESCRIPTION

As mentioned above, AI-based CSI reporting in wireless communication networks may be improved in several ways. An object of embodiments herein is therefore to improve AI-based CSI reporting in wireless communication networks.

According to a reference solution a UE/chipset vendor may train a single encoder to work well with a single decoder. However, UE/chipset vendors have expressed concerns that they will need to implement different encoders for every NW vendor decoder. That is, UE/chipset vendors will need to design, train, test, and implement, at least one encoder for each NW decoder.

It is desirable to design a CSI reporting solution where a single trained UE encoder may be trained to work well with multiple NW-side decoders.

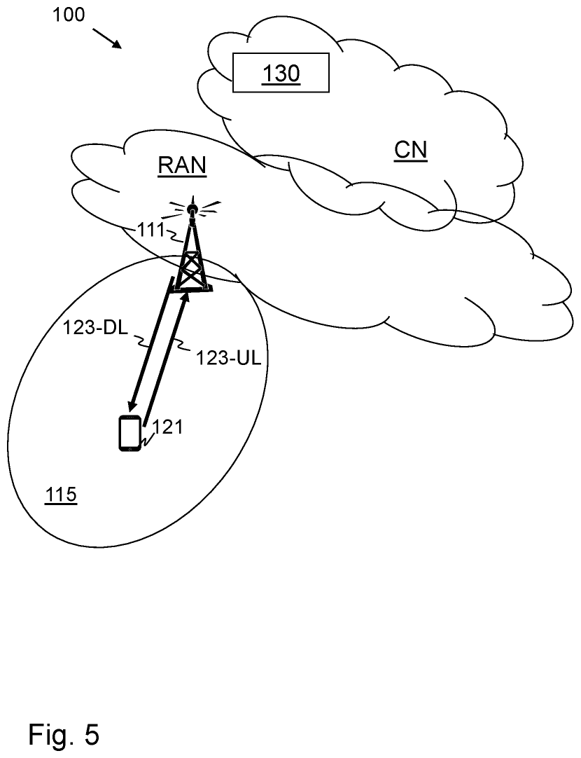

Embodiments herein relate to wireless communication networks in general. FIG. 5 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

Network nodes, such as radio access nodes, operate in the wireless communications network 100. FIG. 5 illustrates a radio access node 111. The radio access node 111 provides radio coverage over a geographical area, a service area referred to as a cell 115, which may also be referred to as a beam or a beam group of a first radio access technology (RAT), such as 5G, LTE, Wi-Fi or similar. The radio access node 111 may be a NR-RAN node, transmission and reception point e.g. a base station, a radio access node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area depending e.g. on the radio access technology and terminology used. The respective radio access node 111 may be referred to as a serving radio access node and communicates with a UE with Downlink (DL) transmissions on a DL channel 123-DL to the UE and Uplink (UL) transmissions on an UL channel 123-UL from the UE.

A number of wireless communications devices operate in the wireless communication network 100, such as a UE 121.

The UE 121 may be a mobile station, a non-access point (non-AP) STA, a STA, a user equipment and/or a wireless terminals, that communicate via one or more Access Networks (AN), e.g. RAN, e.g. via the radio access node 111 to one or more core networks (CN) e.g. comprising a CN node 130, for example comprising an Access Management Function (AMF). It should be understood by the skilled in the art that “UE” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

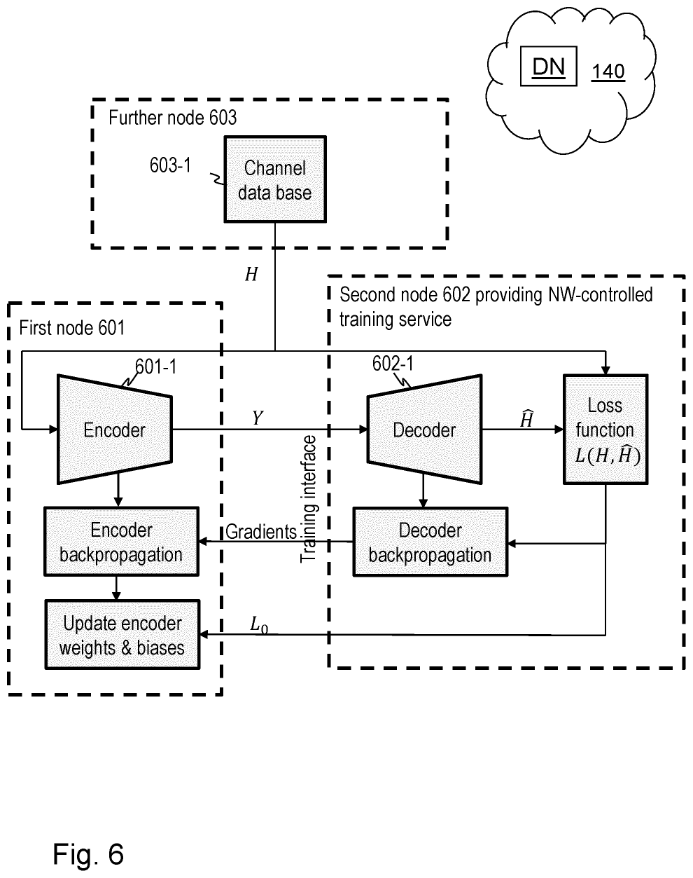

A reference solution will now be described in relation to FIG. 6. In detail FIG. 6 illustrates a first node 601 comprising a Neural Network, NN,-based Auto Encoder, AE,-encoder 601-1. The first node 601 may also be referred to as a training apparatus.

The first node 601 is configured for training the AE-encoder 601-1 in a training phase of the AE-encoder 601-1. The AE-encoder 601-1 is trained to provide encoded CSI from a first communications node, such as the UE 121, to a second communications node, such as the radio access node 111, over a communications channel, such as the UL channel 123-UL, in a communications network, such as the wireless communications network 100. The CSI is provided in an operational phase of the AE-encoder wherein the AE-encoder 601-1 is comprised in the first communications node 121.

FIG. 6 further illustrates a second node 602 comprising an NN-based AE-decoder 602-1 and having access to the channel data. The second node 602 may provide a network-controlled training service for AE-encoders to be deployed in the first communications node 121, such as a UE. The NN-based AE-decoder 602-1 may comprise a same number of input nodes as a number of output nodes of the AE-encoder 601-1.

The first node 601 may have access to one or more trained NN-based AE-encoder models for encoding the CSI. The second node 602 may have access to one or more trained NN-based AE-decoder models for decoding the encoded CSI provided by the first node 602.

The implementation of the AE-decoder 602-1 may not be fully known to the first node 601. For example, the implementation of the AE-decoder 602-1 may be proprietary to the vendor of a certain base station. However, some parameters of the AE-decoder 602-1, like a number of inputs of the AE-decoder 602-1, may be known to the first node 601. Thus, the implementation of the AE-decoder excluding the encoder-decoder interface may not be known to the first node 601.

FIG. 6 further illustrates a further node 603 comprising a channel data base 603-1. The channel database 603-1 may be a channel data source.

In FIG. 6 the first node 601, the second node 602 and the third node 602 have been illustrated as single units. However, as an alternative, each node 601, 602, 603 may be implemented as a Distributed Node (DN) and functionality, e.g. comprised in a cloud 140 as shown in FIG. 6, may be used for performing or partly performing the methods. There may be a respective cloud for each node.

FIG. 6 may also be seen as an illustration of an embodiment of a training interface between the second node 602 providing the network-controlled training service and the UE/chipset-vendor training apparatus 601. In other words, FIG. 6 illustrates a standardized development domain training interface that enables UE/chipset vendors and NW vendors to jointly train a UE encoder together with a NW decoder, without exposing proprietary aspects of the encoders and decoders.

A multi-vendor training setup may consist of a channel data service and a NW-decoder training service:
The channel data service provides training, validation, and test channel data.
The NW-vendor controlled training service provides a solution for UE/chipset vendors (e.g., research and/or development labs) to train candidate UE encoders against the NW's pre-trained decoders.

Details of the second node 602 and/or the network-controlled training service, such as decoder architecture, trainable parameters, a reconstructed channel A, a loss function, and a method to compute gradients may be transparent to the UE/chipset-vendor training apparatus 601. Instead, UE/chipset-vendor training apparatus 601 is provided with the gradients of the input to the decoder.

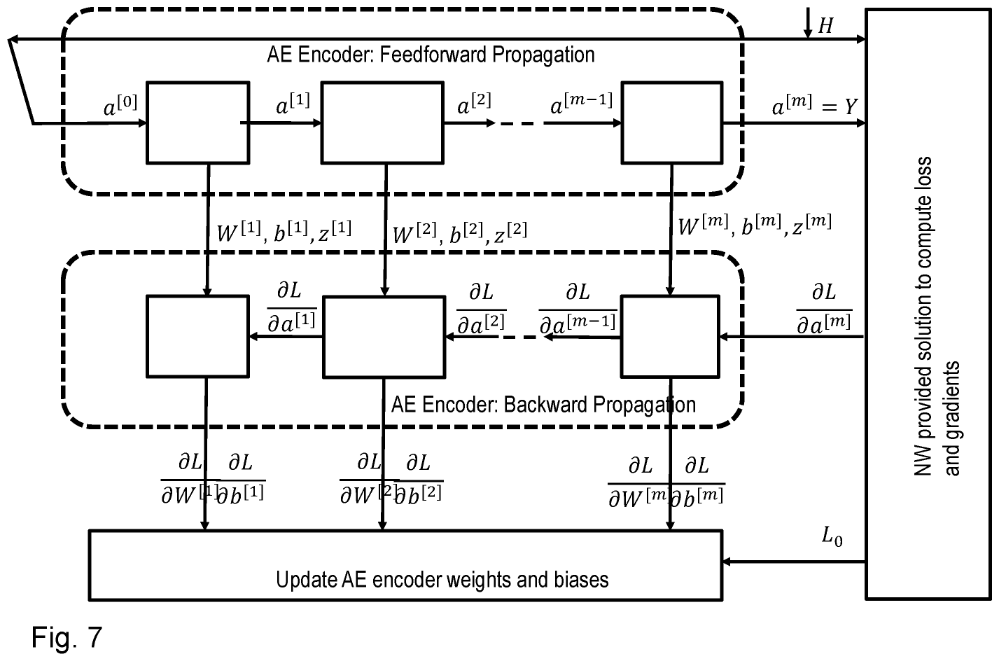

The reference solution to handle AE-based CSI reporting will now be described with reference to FIG. 7 which illustrates how a UE/chipset vendor training apparatus, such as the node 601, may train an AE encoder 601-1 using the network vendor's training service provided by the second node 602.

The UE/chipset and NW vendor have shared access to the channel data service. The UE/chipset vendor compresses (mini-) batches of the channel data and transmits the compressed output of its encoder to the NW-vendor controlled training service.

Using methods transparent to the UE/chipset vendor, the NW applies its decoder to the compressed encoder output provided by the UE vendor. The NW vendor computes the corresponding loss (using a proprietary loss function) and computes the gradients of the input to the decoder. The NW signals the loss and gradients back to the UE/chipset vendor.

Embodiments herein may reuse the development domain training infrastructure described above in relation to FIGS. 6 and 7. In brief, embodiments herein may improve UE/chipset proprietary procedures for training encoders and provide enhancements to the training interface that simplifies the training procedure for UE/chipset vendors.

Suppose that the UE/chipset vendor wants to simultaneously train a single encoder to work well with two trained/frozen gNB decoders:
Decoder A from NW vendor A, and
Decoder B from NW vendor B.

Embodiments herein are described in relation to two decoders for simplicity. However, embodiments herein are applicable for two or more decoders.

### Training Infrastructure Setup

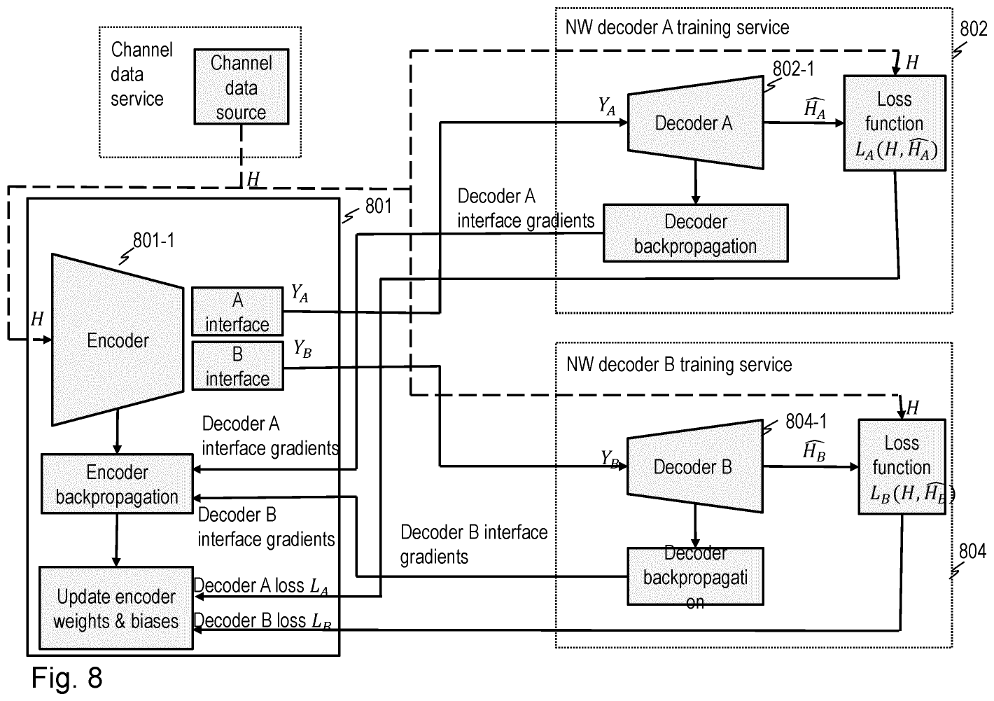

The UE/chipset vendor connects its encoder training infrastructure to NW vendor A's training infrastructure and NW vendor B's training infrastructure. In some embodiments when the UE/chipset vendor connects its encoder training infrastructure to NW vendor A's training infrastructure and NW vendor B's training infrastructure they may do some kind of negotiation which may include a loss function definition. An example setup is illustrated in FIG. 8. In FIG. 8 a first node 801 corresponds to the first node 601 of FIG. 6. The first node 801 comprises a NN-based AE-encoder 801-1.

### Encoder Architecture

The UE/chipset vendor designs its encoder 801-1 to have two or more outputs payloads—e.g. a PUSCH/PUCCH payload for decoder A and a PUSCH/PUCCH payload for decoder B in FIG. 8. Or, put another way, the output of the encoder 801-1 is split-one part mapping to the UL channel for a first decoder A 802-1 in the second node 602, 802 and the other to the UL channel for a second decoder B 804-1 in a third node 804.

Details of the encoder architecture are left for UE implementation.

The following details may apply to the encoder output PUSCH/PUCCH payloads:
The encoder outputs for decoder A and B will both need to be quantized for transmission over PUSCH or PUCCH during inference (live use in the network).
The PUSCH/PUCCH payload for decoder A will be transmitted over the air interface and, therefore, it needs to follow the corresponding air interface specification for decoder A (e.g., payload size, bit orderings, control/data channel, and associated signalling). Similarly, the payload for decoder B should also follow the air interface specification for decoder B.

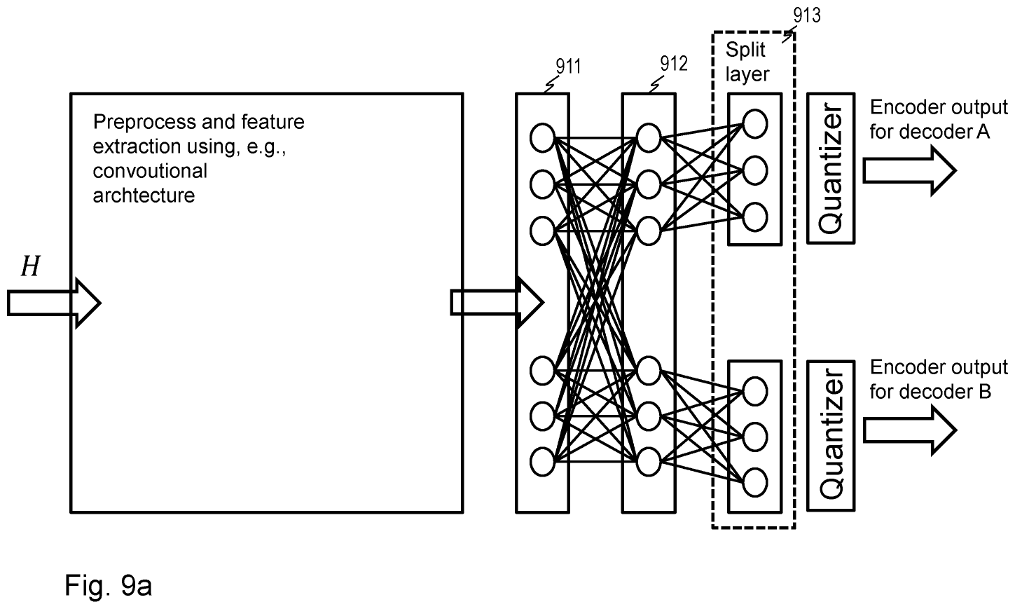

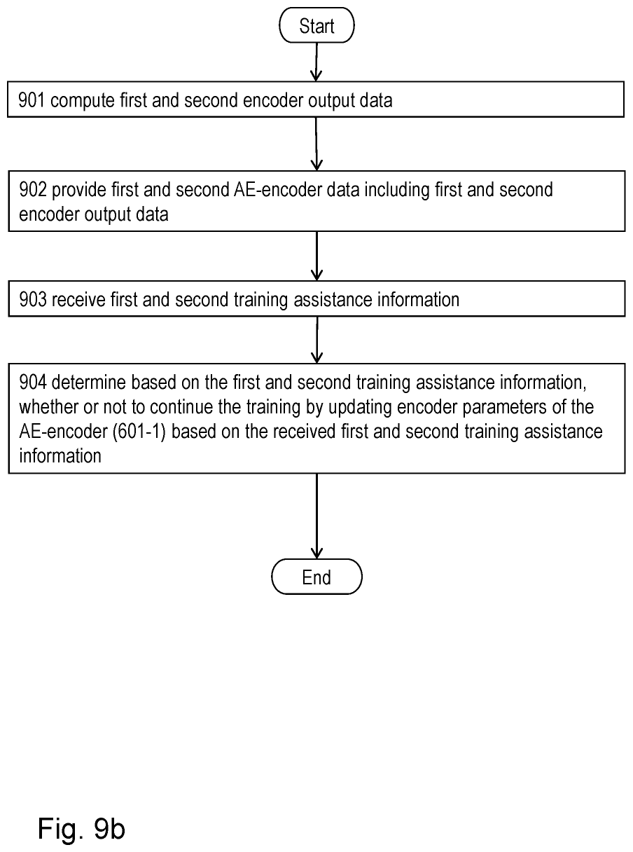

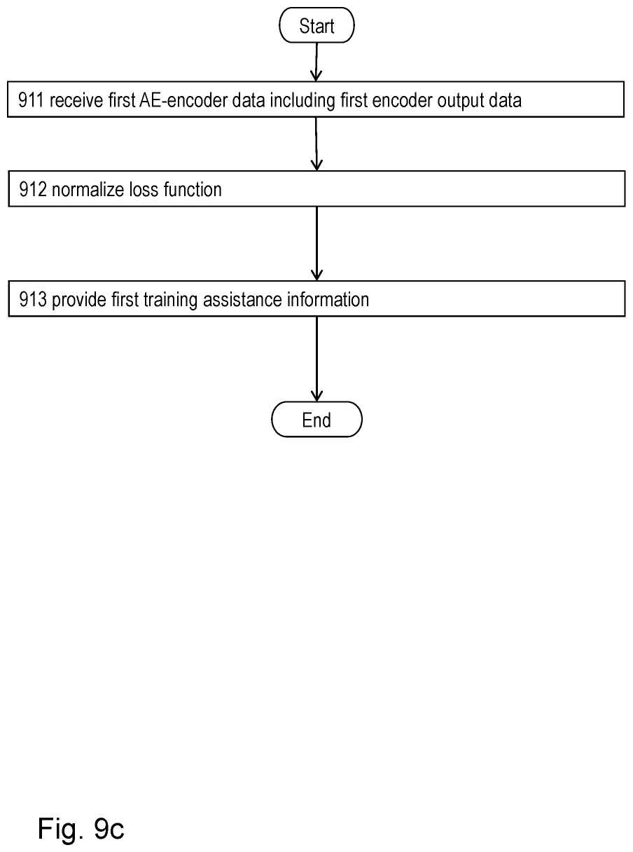

An example encoder architecture is illustrated in FIG. 9a.
The channel H is fed into the neural network on the left. The first part of the neural network may pre-process the channel and extract important features. It is common, but not necessary, to use a convolutional architecture for pre-processing and feature extraction. The pre-processing and feature extraction steps will be jointly trained to work well for both decoders. The pre-processing and feature extraction steps may also be performed outside the neural network, e.g., on a regular CPU.
The pre-processing step is followed by several dense layers before the air interface (a typical, but not necessary, design pattern). The last dense layer splits the encoder output into separate payloads for each decoder. The output of each layer is a vector—parts of that vector are used (become input) to one decoder while others go to another decoder. For example, if the vector has six elements and one dimension such as [0, 3, 4, 6, 7, 8]—the first three elements [0,3,4] become input to the first decoder while the second three elements [6,7,8] go to another decoder. Both payloads are quantized.

The encoder architecture of FIG. 9a has similarities to split learning architectures. A difference is that the PUSCH/PUCCH payloads in FIG. 9a are quantized (to bits) for transmission over the uplink. This quantization appears after the split layer, i.e. after the bottleneck layer that holds the compressed, also called latent, representation, Y, of the input data X.

Embodiments herein for training of AEs for CSI reporting will now be described with reference to a flow chart in FIG. 9b and with continued reference to FIGS. 8 to 9a. Embodiments herein presents a procedure that enables UE/chipset vendors to train a single encoder to work well with several decoders (possibly supplied by different network vendors).

Embodiments herein disclose a method, performed by the first node 801. The first node comprises the NN-based AE-encoder 601-1, 801-1. The method is for training the AE-encoder in a training phase of the AE-encoder. The AE-encoder 601-1 is trained to provide encoded Channel State Information, CSI, from the first communications node 121, such as a UE, to a second communications node 111, such as a radio access node, over the communications channel 123-UL in the communications network 100. The CSI is provided in an operational phase of the AE-encoder. In the operational phase the AE-encoder 601-1 or an equivalent encoder may be comprised in the first communications node 121.

In action 901 the first node 801 may encode a (mini-) batch of channels with the encoder, producing two output payloads-one for decoder A and another for decoder B. In other words, the first node 801 computes with the AE-encoder 601-1, a first and second encoder output data based on a same set of input channel data representing the communications channel 123-DL between the first communications node 121 and the second communications node 111.

In addition to the channel data the encoder 601-1 may obtain further input which may be taken into account when computing the first and second encoder output data. Such further input may be auxiliary information such as a device type of the UE 121, version of a UE model, antenna configuration of the UE and other hardware related capabilities of the UE and of the network.

In action 902, the first node 801 sends the first payload YA to the second node 802 for decoder A and the second payload Y_{B} to the third node 804 for decoder B.

In other words, the first node 801 provides first AE-encoder data to the second node 602, 802 comprising the first NN-based AE-decoder 602-1 and having access to the channel data. The first AE-encoder data includes the first encoder output data.

The first node 801 further provides second AE-encoder data to the third node 804 comprising the second NN-based AE-decoder 804-1 and having access to the channel data. The second AE-encoder data includes the second encoder output data.
The third node 804 may be the same node as the second node 802.

In action 903 the training services may return (to the first node 801) the gradients of the decoder input layer together with the corresponding losses, as illustrated in FIG. 6.

Thus the first node 801 receives, from the second node 802, first training assistance information.

The first node 801 further receives, from the third node 804, second training assistance information.

In some embodiments the first and/or second training assistance information comprises one or more of: a gradient vector of a loss function of the respective AE, a loss value of the loss function, an indication of the loss, an indication of whether or not the AE-encoder 601-1 has achieved sufficient training performance on the shared channel data when used with the AE-decoder 602-1 such that a pass criterion is fulfilled, wherein the loss quantifies a reconstruction error of the shared channel data.

In some embodiments computing with the AE-encoder 601-1 the first and second encoder output data comprises quantizing the first and second AE-encoder data.

The first node 801 may receive an indication of the loss function from the second node 802 and/or the third node 804. Loss functions (MSE, MAE etc.) may be agreed upon in advance since they are provided as input to the optimizer and for the optimizer to measure its progress and also to communicate loss with other interested parties, in this case the other encoder for example. The optimizer is some technique, e.g., gradient descent, which allows the encoder/decoder to reconstruct a given input with as small loss as possible. If Encoder-Decoder are all trained in the same node the negotiation is straightforward and requires no signalling. If encoder is in one node and decoder in another certain signalling is needed to be communicated before hand. That is, whoever initiates the process may provide a list of loss functions and then the parties may acknowledge and use the ones that are supported commonly by all. The loss function may also originate from the Channel data source or some other entity that lacks standardization.

In action 904 the first node 801 may use the reported gradients and losses to update the AE encoder's (601-1) trainable parameters using proprietary methods. The UE/chipset vendor may, for example, simply combine (i.e. sum) the two losses together (or take a weighted average or maximum) and run a standard gradient decent based optimizer (e.g., ADAM).

The training process continues until the AE encoder (601-1) achieves a certain performance for both decoders 802-1, 804-1 (e.g. specified by each NW vendor).

Thus, the first node 801 determines, based on the first and second training assistance information, whether or not to continue the training by updating encoder parameters of the AE-encoder 601-1 based on the received first and second training assistance information.

In some embodiments determining whether or not to continue the training comprises determining whether or not a first pass criterion of a first output of a first loss function of the AE is fulfilled based on the received first training assistance information and determining whether or not a second pass criterion of a second output of a second loss function of the AE is fulfilled based on the received second training assistance information.

The first NN-based AE-decoder 602-1 may use the same loss function as the second NN-based AE-decoder 603-1.

Embodiments herein for training of AEs for CSI reporting will now be described with reference to a flow chart in FIG. 9c and with continued reference to FIGS. 8 to 9a. The flow chart illustrates a method for training the AE-encoder in a training phase of the AE-encoder. The method is performed by the second node 602, 802 and/or third node 804. However, the actions will be described from the second node's perspective.
In action 911 the second node 602, 802 may receive first AE-encoder data, including first encoder output data, from the first node 601, 801.
In action 912 the second node 602, 802 may normalize the loss function. This may be the case if the second node 802 and the third node 804 (NW decoder training services) use different loss functions.
In action 913 the second node 602, 802 may provide first training assistance information to the first node 601, 801.

### Inference

The trained encoder may be deployed to UEs in the field by, for example, a firmware over the air update. The NW may first request the UE to provide its capabilities in decoding options. For example, that it supports decoder A and B, identified via some unique ID configured after training, or defined during the firmware upgrade. In a related embodiment, the NW requests the support for a certain decoder option, and the UE responds whether it supports such decoder or not. Another input to the decoder (and to the process) from the UE may also be the version of the latent space that it receives. This may be important if the network needs to remain backwards compatible.

The NW configures the UE to use either decoder A or decoder B, depending on the gNB vendor. This configuration may be done via RRC and may be explicit or implicit.

Suppose that the UE is configured to report CSI for decoder A. The UE compresses its CSI-RS based channel estimate H with the encoder and only reports the first output payload (i.e., the payload trained for decoder A). The UE can simply drop the second payload (i.e., the payload trained for decoder B). Similarly, if the UE is configured to report CSI for decoder B, then it only reports the second payload.

Note: We have assumed, for simplicity, that the UE always produces two CSI reports—one for decoder A and the other for decoder B. This can be power and computationally inefficient—the extent of which depends on the exact encoder architecture. In practice, the UE/chipset vendor will likely optimize the encoder for inference mode since there is no reason to produce two reports. In one example, the UE vendor may simply drop nodes in the neural network that are not needed (e.g., the top or bottom part of the split layer in FIG. 9a). These details, however, are left for UE/chipset implementation.

### DETAILED EMBODIMENTS

### Training Interface Signalling Enhancements

The proprietary training procedure outlined above enables the first node 801 (UE/chipset vendor) to train a single encoder to work with multiple NW decoders, e.g. using the training interfaces defined above.

However, it may not always be possible to get good performance—the two NW decoders themselves might be incompatible. For example, perhaps the decoders have different architectures and use different loss functions.

The following embodiments are directed to signalling during the training that will help the first node 801 (UE/chipset vendors) to find good NW-decoder pairings for which the encoder will likely pass a test requirement and improve performance of the encoder training. Finding a NW-decoder pairing means to find a NW-decoder to form a pair with the encoder in the first node 801.
embodiment 1: The second node 802 and third node 804 (NW decoder training services) use the same loss functions, which may be specified, documented, or signalled to the first node 801 (UE/chipset vendor). An indication of the loss function or of using the same loss function may be signalled before the training process begins.
embodiment 2: The second node 802 and third node 804 (NW decoder training services) use different loss functions, but their range is normalized (e.g., to [0,1]). To account for loss functions that may be biased towards larger values (e.g., to improve the decoder's performance for a particular encoder) the NW vendor may supply an expected minimum performance, such as a maximum loss. In another embodiment, the NW vendor may use regularization, e.g., L1 and L2 in the loss, and adjust the lambda in the regularize to align the output of the loss functions. In this case a NW vendor should supply a margin for the adjustment of the lambda value that is acceptable.
embodiment 3: The second node 802 and third node 804 (NW decoder training service) provides meta data about the decoder architecture (e.g., a description or diagram of the architecture).
embodiment 4: A single NW vendor deploys several compatible decoders within its training service, such as within the second node 802 and/or the third node 804) and reports the input gradients and losses for all decoders to the first node 801 (UE/chipset vendor). For example, the different decoders may correspond to different CSI-RS configurations and use cases (e.g., SU- or MU-MIMO use cases). The different decoders may also correspond to different bandwidth parts.
embodiment 5: A single NW vendor deploys several compatible decoders within its training service, such as within the second node 802 and/or the third node 804, and reports the federated (average) gradients and losses for the decoders to the First node 801 (UE/chipset vendor).

Embodiments herein describe proprietary UE/chipset procedures to train a single encoder to work well with multiple decoders using for example the infrastructure proposed above.

In addition, the embodiments herein propose several enhancements to the NW decoder training service signalling specification that may improve performance when UE/chipset vendors jointly train encoders for multiple decoders.

These methods enable UE/chipset vendors to deploy fewer trained encoders to UEs. Some advantages are:
Less memory is needed to deploy the encoders to UEs (fewer trained models).
ML model configuration and lifecycle management issues are simplified (fewer trained models to configure, deploy, and monitor).
On the UE side a single encoder is required to be loaded in memory thus avoiding the cost of switching from one encoder to another when the UE switches to a network from a different vendor.
The latent space per vendor (the split output on the encoder size) may have a different shape for each vendor if that is needed.

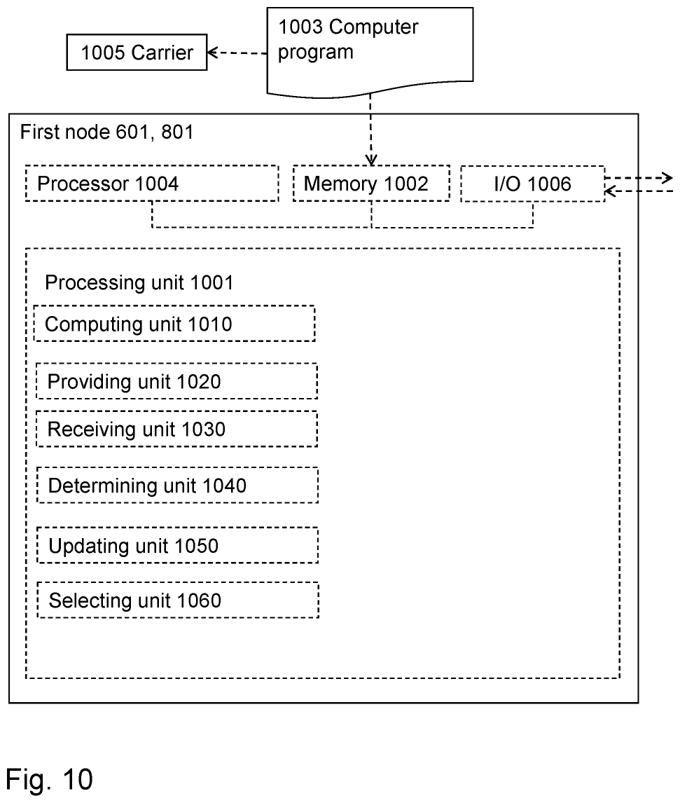

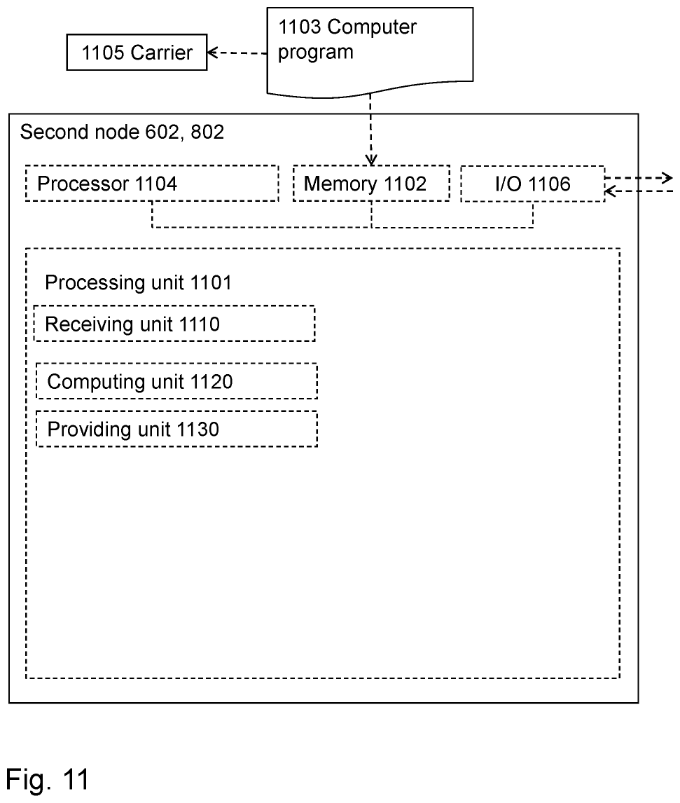

FIG. 10 shows an example of the first node 601, 801 and FIG. 11 shows an example of the second node 602, 802. However, FIG. 11 is also applicable for the third node 804. The first node 601, 801 may be configured to perform the method actions of FIG. 9b above. The second node 602, 802 may be configured to perform the method actions of FIG. 9c above.

The first node 601, 801 is configured to provide first AE-encoder data to a second node 802 comprising a first NN-based AE-decoder 802-1 and having access to channel data representing a communications channel 123-DL between a first communications node 121 and a second communications node 111. The first AE-encoder data includes first encoder output data computed with the AE-encoder 801-1 based on the channel data.

The first node 601, 801 is further configured to provide second AE-encoder data to the third node 804 comprising a second NN-based AE-decoder 804-1 and having access to the channel data, wherein the second AE-encoder data includes second encoder output data computed with the AE-encoder 801-1 based on the same channel data.

The first node 601, 801 is further configured to receive, from the second node 802, first training assistance information.

The first node 601, 801 is further configured to receive, from the third node 804, second training assistance information.

The first node 601, 801 is further configured to determine, based on the first and second training assistance information, whether or not to continue the training by updating encoder parameters of the AE-encoder 801-1 based on the received first and second training assistance information.

In some embodiments the first node 601, 801 is configured to compute with the AE-encoder 801-1 the first and second encoder output data by being configured to quantize the first and second AE-encoder data.

The first node 601, 801 may be configured to determine whether or not to continue the training by being configured to determine whether or not a first pass criterion of a first output of a first loss function of the AE is fulfilled based on the received first training assistance information and by being configured to determine whether or not a second pass criterion of a second output of a second loss function of the AE is fulfilled based on the received second training assistance information.

In some embodiments the first node 601, 801 is configured to receive, from the second node 802 an indication of any one or more of:
the loss function used by the AE-decoder 802-1;
use of the same loss function as the third node 804 comprising the second AE-decoder 804-1;
the expected minimum performance of the combination of the AE-encoder 801-1 and the AE-decoder 802-1;
the margin for the adjustment of the lambda value in the regularize;
meta data about decoder architecture of the decoder 802-1.

When the AE-encoder 801-1 comprises multiple layers 911, 912, 913 then the first node 601, 801 may be configured to compute the first and second encoder output data by being configured to split a single encoder output from a last layer 903 of the multiple layers 901, 902, 903 into the first and second encoder output data, and then quantize the first and second encoder output data.

In some embodiments the first node 601, 801 is configured to compute, with the AE-encoder 601-1, the first and second encoder output data based on a same set of input channel data representing the communications channel 123-DL between the first communications node 121 and the second communications node 111.

The second node 602, 802 is configured to provide to the first node 801, the indication of any one or more of:
the loss function used by the AE-decoder 802-1;
use of the same loss function as the third node 804 comprising the second AE-decoder 804-1;
the expected minimum performance of the combination of the AE-encoder 801-1 and the AE-decoder 802-1, such as the maximum loss;
the margin for the adjustment of the lambda value in the regularize;
meta data about decoder architecture of the decoder 802-1.

In some embodiments the second node 602, 802 is configured to normalize the loss function and provide, to the first node 801, first training assistance information based on the normalized loss.

The first node 601, 801 and the second node 602, 802 may each comprise a respective input and output interface, IF, 1006, 1106 configured to communicate with each other. The input and output interface may comprise a wireless receiver (not shown) and a wireless transmitter (not shown).

The first node 601, 801 and the second node 602, 802 may each comprise a respective processing unit 1001, 1101 for performing the above method actions. The respective processing unit 801, 901 may comprise further sub-units which will be described below.

The first node 601, 801 and the second node 602, 802 may further comprise a respective receiving unit 1030, 1110, and a providing (transmitting) unit 1020, 1130 which may receive and provide (transmit) messages and/or signals.

The first node 601, 801 may further comprise a computing unit 1010 which for example may compute with the AE-encoder 601-1, a first and second encoder output data based on a same set of input channel data.

The first node 601, 801 may further comprise a determining unit 1040 which for example may determine whether or not to continue the training by updating encoder parameters of the AE-encoder 601-1 based on the received first and second training assistance information.

The first node 601, 801 may further comprise an updating unit 1050 which for example may update the trainable encoder parameters.

The first node 601, 801 may further comprise a selecting unit 1060 which for example may select encoder parameters for the inference phase.

The second node 602, 802 may further comprise a computing unit 1120 for example to compute a normalized loss.

The embodiments herein may be implemented through a respective processor or one or more processors, such as the respective processor 1004, and 1104, of a processing circuitry in the first node 601, 801 and the second node 602, 802 together with computer program code for performing the functions and actions of the embodiments herein. The program code mentioned above may also be provided as a computer program product, for instance in the form of a data carrier carrying computer program code for performing the embodiments herein when being loaded into the respective first node 601, 801 and second node 602, 802. One such carrier may be in the form of a CD ROM disc. It is however feasible with other data carriers such as a memory stick. The computer program code may furthermore be provided as pure program code on a server and downloaded to the respective first node 601, 801 and second node 602, 802.

The first node 601, 801 and the second node 602, 802 may further comprise a respective memory 1002, and 1102 comprising one or more memory units. The memory comprises instructions executable by the processor in the first node 601, 801 and second node 602, 802.

Each respective memory 1002 and 1102 is arranged to be used to store e.g. information, data, configurations, and applications to perform the methods herein when being executed in the respective first node 601, 801 and second node 602, 802.

In some embodiments, a respective computer program 1003 and 1103 comprises instructions, which when executed by the at least one processor, cause the at least one processor of the respective first node 601, 801 and second node 602, 802 to perform the actions above.

In some embodiments, a respective carrier 805 and 905 comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the units described above may refer to a combination of analog and digital circuits, and/or one or more processors configured with software and/or firmware, e.g. stored in the respective first node 601, 801 and second node 602, 802, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

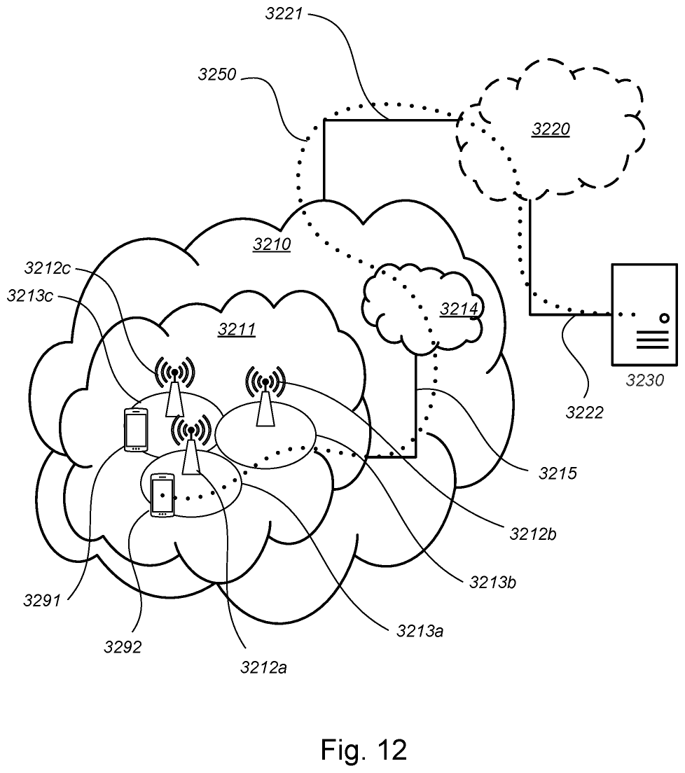

With reference to FIG. 12, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as the source and target access node 111, 112, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

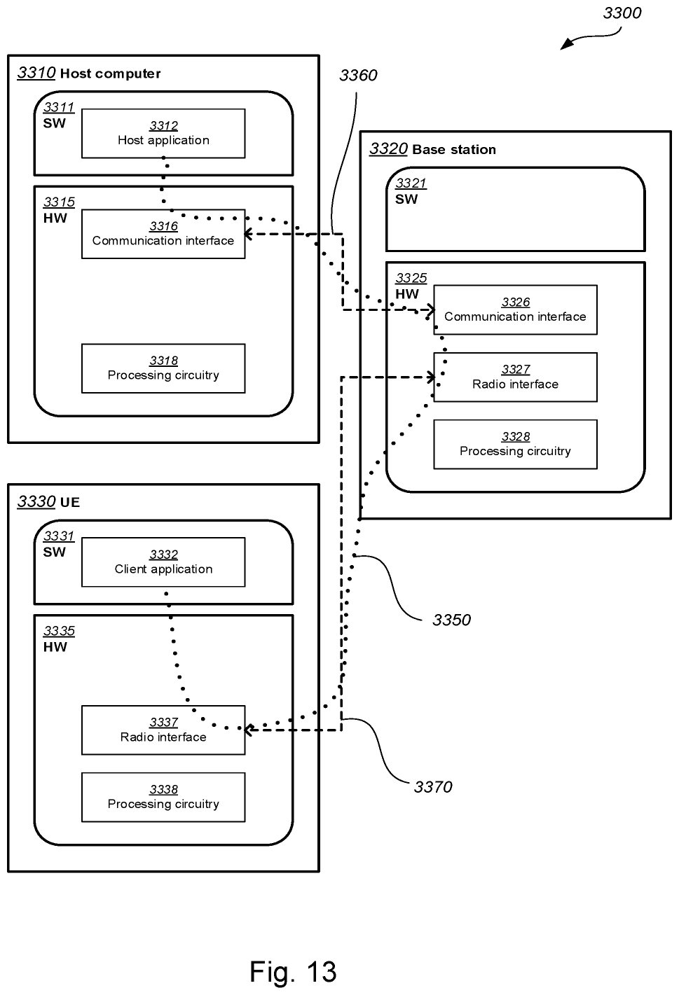

The communication system of FIG. 12 as a whole enables connectivity between one of the connected UEs 3291, 3292 such as e.g. the UE 121, and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230. Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

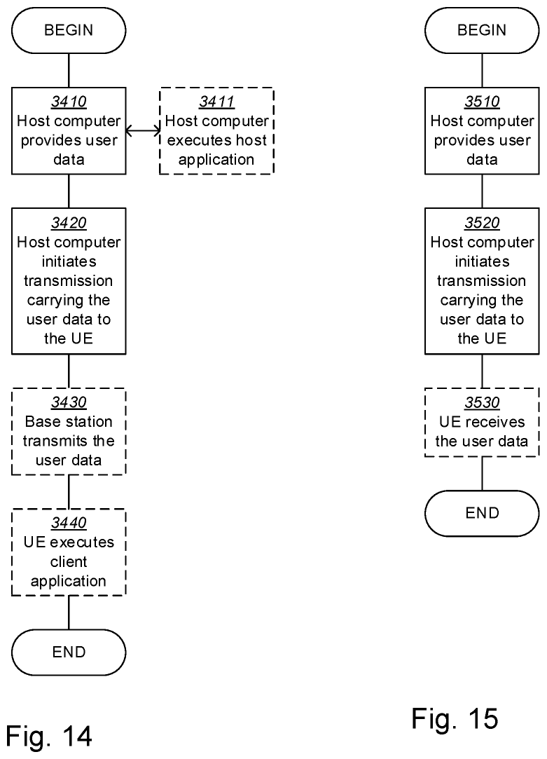

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 14 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 15 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

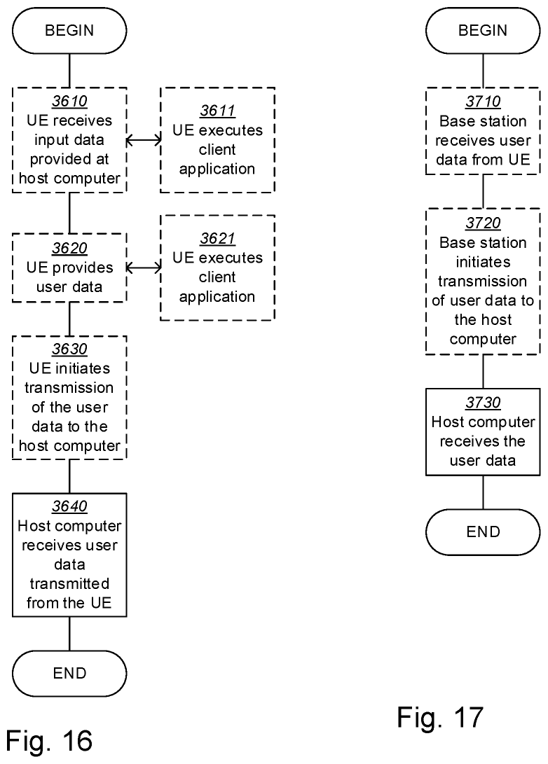

FIG. 16 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 16 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 17 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method, performed by a first node comprising an Auto Encoder, AE, encoder, for training the AE-encoder to provide encoded Channel State Information, CSI, the method comprising:
providing first AE-encoder data to a second node comprising a first NN-based AE-decoder and having access to channel data representing a communications channel between a first communications node and a second communications node, the first AE-encoder data including first encoder output data computed with the AE-encoder based on the channel data;
providing second AE-encoder data to a third node comprising a second NN-based AE-decoder and having access to the channel data, the second AE-encoder data including second encoder output data computed with the AE-encoder based on the same channel data;
receiving, from the second node, first training assistance information;
receiving, from the third node, second training assistance information; and
determining, based on the first and second training assistance information, whether or not to continue the training by updating encoder parameters of the AE-encoder based on the received first and second training assistance information, one or both of the first and second training assistance information comprising a gradient vector of a loss function of the respective first and second AE.

2. The method according to claim 1, wherein the one or both of the first and second training assistance information further comprises one or more of an indication of a loss value of the loss function, an indication of whether or not the AE-encoder has achieved sufficient training performance on the shared channel data when used with the respective AE-decoder such that a pass criterion is fulfilled.

3. The method according to claim 1, wherein computing with the AE-encoder the first and second encoder output data comprises quantizing the first and second AE-encoder data.

4. The method according to claim 1, wherein determining whether or not to continue the training comprises determining whether or not a first pass criterion of a first output of a first loss function of the AE is fulfilled based on the received first training assistance information and determining whether or not a second pass criterion of a second output of a second loss function of the AE is fulfilled based on the received second training assistance information.

5. The method according to claim 1, wherein the first AE-decoder uses the same loss function as the second AE-decoder.

6. The method according to claim 1, further comprising receiving, from the second node an indication of any one or more of:
a loss function used by the AE-decoder;
use of a same loss function as the third node;
an expected minimum performance of a combination of the AE-encoder and the AE-decoder;
a margin for an adjustment of a lambda value in a regularize; and
meta data about decoder architecture of the decoder.

7. The method according to claim 3, wherein the AE-encoder comprises multiple layers and wherein computing the first and second encoder output data comprises splitting a single encoder output from a last layer of the multiple layers into the first and second encoder output data, and then quantizing the first and second encoder output data.

8. The method according to claim 1, further comprising computing, with the AE-encoder, the first and second encoder output data based on a same set of input channel data representing the communications channel between the first communications node and the second communications node.

9. The method according to claim 1, wherein the AE-encoder is trained to provide encoded CSI from the first communications node to the second communications node over the communications channel in the communications network, wherein the CSI is provided in an operational phase of the AE-encoder.

10. A method, performed by a second node comprising an Auto Encoder, AE,-decoder, for assisting in training an AE-encoder, comprised in a first node, to provide encoded Channel State Information, CSI, the method comprising:
providing, to the first node, an indication of any one or more of:
a loss function used by the AE-decoder;
use of a same loss function as a third node comprising a second AE-decoder;
an expected minimum performance of a combination of the AE-encoder and the AE-decoder;
a margin for an adjustment of a lambda value in a regularize; and
meta data about decoder architecture of the decoder.

11. The method according to claim 10, further comprising:
normalizing the loss function; and
providing, to the first node, first training assistance information based on the normalized loss.

12. A first node, comprising an Auto Encoder, AE, encoder, configured for training the AE-encoder to provide encoded Channel State Information, CSI, the first node being further configured to:
provide first AE-encoder data to a second node comprising a first NN-based AE-decoder and having access to channel data representing a communications channel between a first communications node and a second communications node, the first AE-encoder data including first encoder output data computed with the AE-encoder based on the channel data;
provide second AE-encoder data to a third node comprising a second NN-based AE-decoder and having access to the channel data, the second AE-encoder data including second encoder output data computed with the AE-encoder based on the same channel data;
receive, from the second node, first training assistance information;
receive, from the third node, second training assistance information; and
determine, based on the first and second training assistance information, whether or not to continue the training by updating encoder parameters of the AE-encoder based on the received first and second training assistance information.

13. The first node according to claim 12, wherein the one or both of the first and second training assistance information further comprises one or more of an indication of a loss value of the loss function, an indication of whether or not the AE-encoder has achieved sufficient training performance on the shared channel data when used with the respective AE-decoder such that a pass criterion is fulfilled.

14. A second node, comprising an Auto Encoder, AE, decoder, configured for assisting in training an AE-encoder comprised in a first node, to provide encoded Channel State Information, CSI, the second node being further configured to:
provide to the first node, an indication of any one or more of:
a loss function used by the AE-decoder;
use of a same loss function as a third node comprising a second AE-decoder;
an expected minimum performance of a combination of the AE-encoder and the AE-decoder;
a margin for an adjustment of a lambda value in a regularize; and
meta data about decoder architecture of the decoder.

15. The second node according to claim 14, wherein the second node is further configured to:
normalize the loss function; and
provide, to the first node, first training assistance information based on the normalized loss.

16. (canceled)

17. (canceled)

18. The method according to claim 2, wherein computing with the AE-encoder the first and second encoder output data comprises quantizing the first and second AE-encoder data.

19. The method according to claim 2, wherein determining whether or not to continue the training comprises determining whether or not a first pass criterion of a first output of a first loss function of the AE is fulfilled based on the received first training assistance information and determining whether or not a second pass criterion of a second output of a second loss function of the AE is fulfilled based on the received second training assistance information.

20. The method according to claim 2, wherein the first AE-decoder uses the same loss function as the second AE-decoder.

21. The method according to claim 2, further comprising receiving, from the second node an indication of any one or more of:
a loss function used by the AE-decoder;
use of a same loss function as the third node;
an expected minimum performance of a combination of the AE-encoder and the AE-decoder;
a margin for an adjustment of a lambda value in a regularize; and
meta data about decoder architecture of the decoder.

22. The method according to claim 2, further comprising computing, with the AE-encoder, the first and second encoder output data based on a same set of input channel data representing the communications channel between the first communications node and the second communications node.
